(19) United States
(12) Patent Application Publication
(10) Pub. No.: US 2026/0360588 A1
(43) Pub. Date: Nov. 12, 2026

(54) HIGH-VOLTAGE CABLE WITH WARNING FUNCTION

(71) Applicant: Wuxi Henghui Cable Co., Ltd., Wuxi City (CN)

(72) Inventors: Jinlei ZHAO, Wuxi City (CN); Lei JIANG, Wuxi City (CN); Yahong CHU, Wuxi City (CN)

(21) Appl. No.: 19/650,274

(22) Filed: Apr. 16, 2026

(30) Foreign Application Priority Data
May 12, 2025 (CN) 2025106043352

(51) Int. Cl. H01B 7/32; H01B 7/18

(52) U.S. Cl. CPC H01B 7/32; H01B 7/181; H01B 7/184; H01B 7/185

(57) ABSTRACT

The present disclosure relates to a high-voltage cable with a warning function. Through the provision of a self-sensing passage, an inert gas filled in the self-sensing passage increases the overall elasticity of the cable when the cable is intact, thereby providing a buffering and protective effect for the cable. When breakage occurs in the cable, gas exchange takes place between the inert gas in the self-sensing passage and ambient air. On one hand, the gas exchange triggers an audible and visual alarm, thereby facilitating timely maintenance by an operator. On the other hand, under the action of a unidirectional gas blocking piece, a plurality of warning rings located between a breakage point and a node ring are caused to change color synchronously; this not only enlarges a warning area, but also assists the operator in quickly locating the breakage point, thereby improving maintenance efficiency.

### CROSS-REFERENCE TO RELATED APPLICATIONS

This application claims priority to Chinese Patent Application No. 202510604335.2, filed on May 12, 2025, the content of which is incorporated herein by reference in its entirety.

### TECHNICAL FIELD

The present disclosure relates to a high-voltage cable, and more specifically, to a high-voltage cable with a warning function that is applicable to the technical field of cables.

### BACKGROUND

A high-voltage cable is a power cable used for transmitting voltages between 1 kV and 1000 kV, and is primarily applied in power transmission and distribution. A high-voltage cable comprises, from the inside outward, a conductor, an insulation, an inner sheath, a filler (armor), and an outer insulation.

When the cable is under high load, the temperature of the core rises, causing the cable to thermally expand, and this thermal expansion makes the cable prone to breakdown. In addition, during use, portions of the cable are exposed to the external environment and are susceptible to rupture due to unexpected compression, friction, dragging, or the like, resulting in breakdown. However, when such breakage and breakdown occur, the breakage and breakdown are difficult to detect in a timely manner, so that the power system continues power transmission under such conditions, thereby posing a significant potential safety hazard.

To address the above problems, Chinese Patent Publication No. CN118692740A discloses a power cable with a temporary repair function. By providing adhesives of different colors, when the cable core operates normally and a break appears in the exterior, maintenance personnel can conveniently locate the breakage point, thereby providing a warning and facilitating quick troubleshooting. However, the approach described in CN118692740A relies primarily on manual inspection and may result in missed detection when an abnormality occurs, thereby leaving certain potential safety hazards.

Chinese Patent Publication No. CN119314738A discloses a power cable with automatic monitoring. When mist or rainwater in the environment enters a breakage point of the insulation layer, spherical sponges absorb water and expand, thereby protruding outward, and this expansion allows an operator to precisely locate the breakage point. Because the spherical sponges, filler sponges, and columnar sponges all have water-absorbing properties, heat transfer occurs between the water and a bottom ring block, thereby causing the temperature of the bottom ring block at that location to be lower than that of bottom ring blocks at other locations where the insulation layer is not aged or broken. In this way, the operator is informed of the abnormality at that location, allowing timely discovery and timely repair, thereby preventing further damage to the insulation layer and greatly increasing the service life and operational safety of the power cable. However, the indication of the breakage point in CN119314738A depends on external water. On one hand, the indication is significantly affected by weather conditions; when there is no rain, the breakage point is difficult to indicate. On the other hand, when breakage occurs, contact between water and the cable poses a risk of electric leakage. Thus, the breakage point location method described in CN119314738A presents certain potential safety hazards.

Therefore, a high-voltage cable with a warning function is provided. The high-voltage cable does not rely on manual inspection, and after breakage occurs, can directly indicate a breakage point under low potential safety hazard conditions.

### SUMMARY

In view of the above prior art, the present disclosure addresses the technical problem that a cable is prone to wear and breakdown, making a breakage abnormality difficult to detect in a timely manner and thereby posing a significant potential safety hazard.

To solve the above problems, the present disclosure provides a high-voltage cable with a warning function. The high-voltage cable includes a plurality of cable cores, an insulation layer wrapped around outer portions of the plurality of cable cores, an inner protective layer wrapped around the insulation layer, and a plurality of warning protective sleeves fixedly connected in sequence along an axial direction of the inner protective layer and wrapped around an outer portion of the inner protective layer; wherein each of the warning protective sleeves includes an outer protective sleeve, a node ring fixedly connected to an end portion of the outer protective sleeve, and a plurality of warning rings fixedly connected to an outer portion of the outer protective sleeve;
a collection cavity is defined inside the node ring; an air sensor is disposed inside the collection cavity; an audible and visual alarm is fixedly mounted on an outer portion of the node ring; the audible and visual alarm is in signal connection with the air sensor; a self-sensing passage is defined inside the outer protective sleeve; a gas guide tube is fixedly connected to an inner wall of each of the warning rings; and the gas guide tube is fixedly arranged to extend through the outer portion of the outer protective sleeve and is in fluid communication with the self-sensing passage; and
the self-sensing passage includes a plurality of annular inner cavities and a plurality of passage holes respectively located between every two adjacent annular inner cavities; the plurality of passage holes and the plurality of warning rings are arranged in a mutually spaced manner; a unidirectional gas blocking piece is fixedly connected to an inner wall of each of the passage holes; a vent hole is further defined at an end of the node ring facing the outer protective sleeve; the vent hole communicates one of the annular inner cavities with the collection cavity; and the collection cavity and the plurality of annular inner cavities are each saturated with an inert gas.

In the above high-voltage cable with a warning function, through the provision of a self-sensing passage, an inert gas filled in the self-sensing passage increases the overall elasticity of the cable when the cable is intact, thereby providing a buffering and protective effect for the cable. When breakage occurs in the cable, gas exchange takes place between the inert gas in the self-sensing passage and ambient air. On one hand, the gas exchange triggers an audible and visual alarm, thereby facilitating timely maintenance by an operator. On the other hand, the warning ring at the breakage site on the cable undergoes a distinct color change, and this color change assists the operator in quickly locating the breakage point, thereby improving maintenance efficiency.

As a further improvement, each of the warning rings is of a hollow transparent structure, and an inner wall of each of the warning rings is coated with polyphenol oxidase.

As a further improvement, the gas guide tube is in fluid communication with a corresponding one of the annular inner cavities, and an inner portion of each of the warning rings is further saturated with the inert gas.

As a further improvement, the unidirectional gas blocking piece includes a positioning ring and a self-adaptive piece fixedly connected to an end of the positioning ring close to the node ring; the self-adaptive piece includes two wall-attaching half-rings, a pre-bent section fixedly connected between end portions of the two wall-attaching half-rings, and a shielding piece fixedly connected to inner walls of the two wall-attaching half-rings and an inner wall of the pre-bent section; and the pre-bent section and the two wall-attaching half-rings together form a complete ring.

As a further improvement, an upper one of the wall-attaching half-rings is fixedly connected to the positioning ring; a lower one of the wall-attaching half-rings is in contact with but not fixed to the positioning ring; each of the two wall-attaching half-rings is of a rigid structure; the pre-bent section is of an elastic structure; and the shielding piece is made of a sealed flexible material.

As a further improvement, an indicating ring groove is further defined at an outer portion of the node ring, and the indicating ring groove and the collection cavity are offset from each other.

As another improvement, the self-sensing passage further includes a plurality of annular outer cavities formed inside the outer protective sleeve; the plurality of annular outer cavities and the plurality of gas guide tubes are arranged in a mutually spaced manner; and each of the plurality of annular outer cavities is coaxial with a corresponding one of the annular inner cavities and located outside the corresponding one of the annular inner cavities.

As an additional improvement supplementary to the foregoing improvement, among one or two of the annular outer cavities adjacent to the gas guide tube, the gas guide tube is in fluid communication with one of the annular outer cavities that is on a side close to the node ring.

In summary, through the provision of a self-sensing passage, an inert gas filled in the self-sensing passage increases the overall elasticity of the cable when the cable is intact, thereby providing a buffering and protective effect for the cable. When breakage occurs in the cable, gas exchange takes place between the inert gas in the self-sensing passage and ambient air. On one hand, the gas exchange triggers an audible and visual alarm, thereby facilitating timely maintenance by an operator. On the other hand, under the action of a unidirectional gas blocking piece, a plurality of warning rings located between a breakage point and a node ring are caused to change color synchronously; this not only enlarges a warning area, but also assists the operator in quickly locating the breakage point, thereby improving maintenance efficiency. Moreover, compared with the prior art, the high-voltage cable provides a warning and allows maintenance and repair to be performed before the cable is completely broken down, thereby significantly reducing potential safety hazards.

### BRIEF DESCRIPTION OF THE DRAWINGS

FIG. 1 is a perspective view of a high-voltage cable according to Embodiment 1 of the present disclosure.

FIG. 2 is a radial cross-sectional view of the high-voltage cable according to Embodiment 1 of the present disclosure.

FIG. 3 is a perspective view of a warning protective sleeve portion according to Embodiment 1 of the present disclosure.

FIG. 4 is a half-sectional perspective view of the warning protective sleeve according to Embodiment 1 of the present disclosure.

FIG. 5 is a schematic view of portion A in FIG. 4.

FIG. 6 is a schematic cross-sectional view of the warning protective sleeve according to Embodiment 1 of the present disclosure.

FIG. 7 is a perspective view of a gas-blocking side of a unidirectional gas blocking piece according to Embodiment 1 of the present disclosure.

FIG. 8 is a perspective view of the gas-blocking side of the unidirectional gas blocking piece in an open state according to Embodiment 1 of the present disclosure.

FIG. 9 is a perspective view of a gas-passing side of the unidirectional gas blocking piece in an open state according to Embodiment 1 of the present disclosure.

FIG. 10 is a cross-sectional view of the warning protective sleeve when breakage occurs according to Embodiment 1 of the present disclosure.

FIG. 11 is a schematic perspective view of the high-voltage cable after breakage occurs according to Embodiment 1 of the present disclosure.

FIG. 12 is a transverse cross-sectional schematic view of a warning protective sleeve according to Embodiment 2 of the present disclosure.

FIG. 13 is a comparison view when breakage occurs in the high-voltage cable according to Embodiment 1 and Embodiment 2 of the present disclosure.

Reference numerals in the drawings:

11. cable core; 12. insulation layer; 13. inner protective layer; 21. outer protective sleeve; 22. node ring; 23. warning ring; 201. indicating ring groove; 202.
annular inner cavity; 203. collection cavity; 204. vent hole; 205. gas guide tube; 206. passage hole; 207. annular outer cavity; 3. unidirectional gas blocking piece; 31. positioning ring; 321. wall-attaching half-ring; 322. pre-bent section; 323. shielding piece; 4. air sensor; 5. audible and visual alarm.

### DETAILED DESCRIPTION OF THE EMBODIMENTS

The following provides a detailed description of two embodiments of the present disclosure with reference to the accompanying drawings.

### Embodiment 1

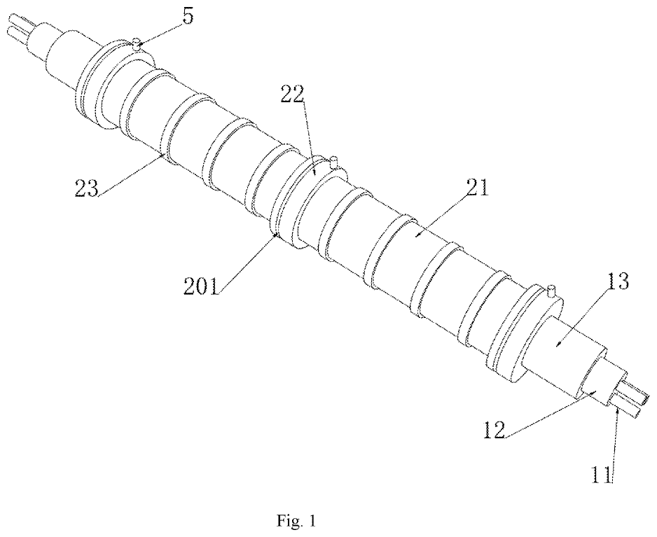

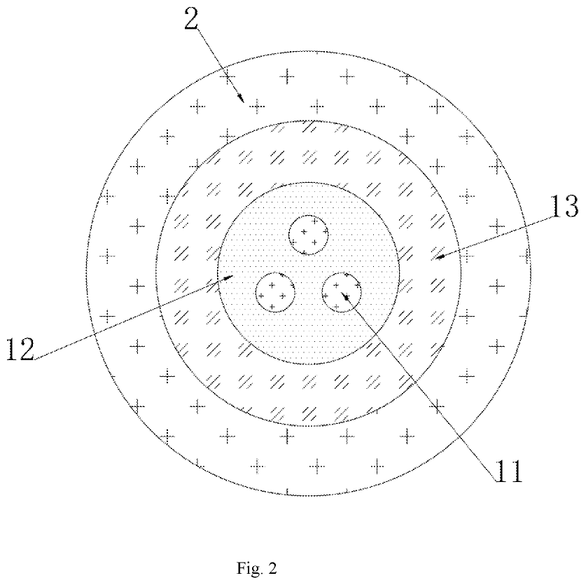

FIGS. 1-2 illustrate a high-voltage cable with a warning function. The high-voltage cable includes a plurality of cable cores 11, an insulation layer 12 wrapped around outer portions of the plurality of cable cores 11, an inner protective layer 13 wrapped around the insulation layer 12, and a plurality of warning protective sleeves fixedly connected in sequence along an axial direction of the inner protective layer 13 and wrapped around an outer portion of the inner protective layer 13. A length of one of the warning protective sleeves is not less than 2 meters. Each of the warning protective sleeves includes an outer protective sleeve 21, a node ring 22 fixedly connected to an end portion of the outer protective sleeve 21, and a plurality of warning rings 23 fixedly connected to an outer portion of the outer protective sleeve 21. Each of the warning rings 23 is of a hollow transparent structure, and an inner wall of each of the warning rings 23 is coated with polyphenol oxidase. Polyphenol oxidase is readily oxidized and changes color upon exposure to air, whereby whether an outer periphery of the high-voltage cable is broken can be detected.

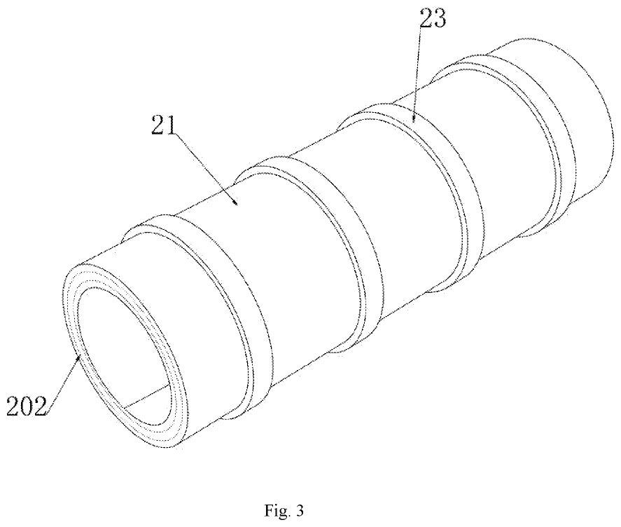

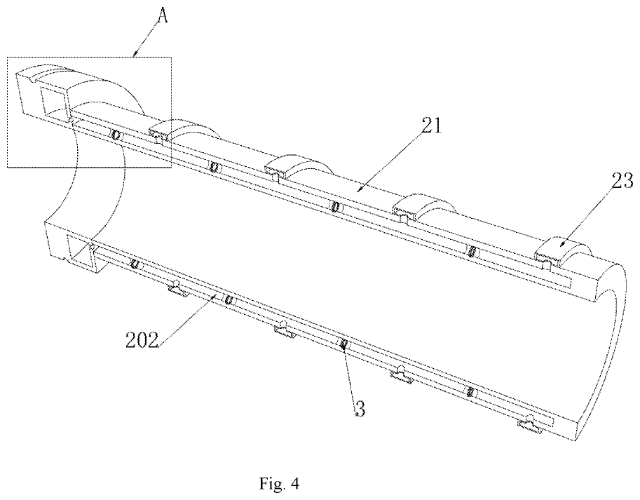

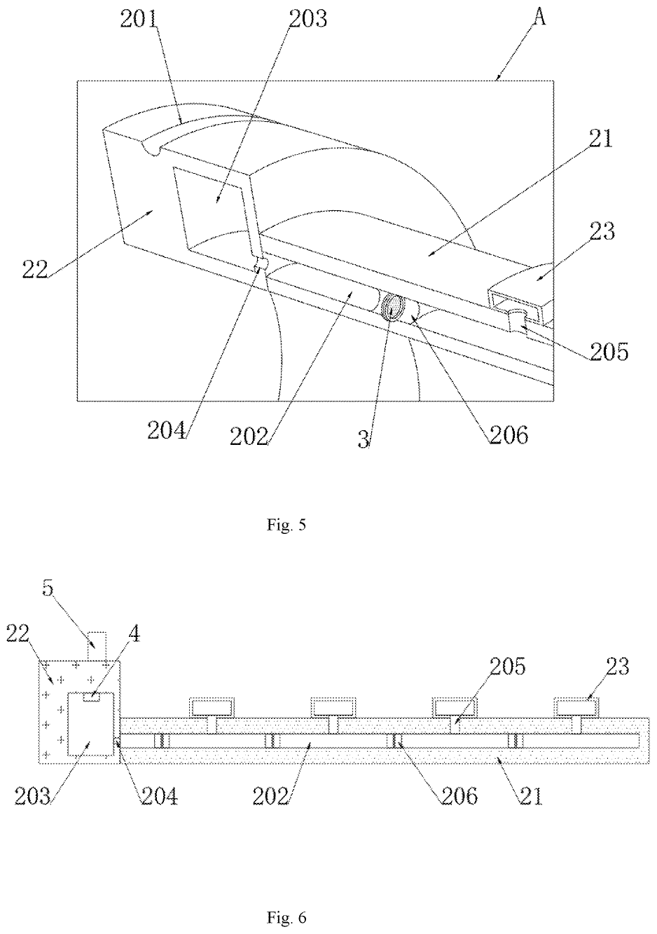

As shown in FIGS. 3-5, a collection cavity 203 is defined inside the node ring 22; an air sensor 4 is disposed inside the collection cavity 203; an audible and visual alarm 5 is fixedly mounted on an outer portion of the node ring 22; the audible and visual alarm 5 is in signal connection with the air sensor 4; a self-sensing passage is defined inside the outer protective sleeve 21; a gas guide tube 205 is fixedly connected to an inner wall of each of the warning rings 23; and the gas guide tube 205 is fixedly arranged to extend through the outer portion of the outer protective sleeve 21 and is in fluid communication with the self-sensing passage. When breakage occurs and a crack depth reaches the self-sensing passage, an amount of the inert gas in the self-sensing passage gradually decreases while an air content gradually increases. After detecting a significant change in the air content, the air sensor 4 triggers the audible and visual alarm 5 to emit an audible and visual alarm, so that a breakage condition of the high-voltage cable is detected before the high-voltage cable is completely broken down, thereby effectively reducing potential safety hazards.

As shown in FIG. 6, the self-sensing passage includes a plurality of annular inner cavities 202 and a plurality of passage holes 206 respectively located between every two adjacent annular inner cavities 202; the plurality of passage holes 206 and the plurality of warning rings 23 are arranged in a mutually spaced manner; a unidirectional gas blocking piece 3 is fixedly connected to an inner wall of each of the passage holes 206; a vent hole 204 is further defined at an end of the node ring 22 facing the outer protective sleeve 21; the vent hole 204 communicates one of the annular inner cavities 202 with the collection cavity 203; and the collection cavity 203 and the plurality of annular inner cavities 202 are each saturated with an inert gas. The gas guide tube 205 is in fluid communication with a corresponding one of the annular inner cavities 202, and an inner portion of each of the warning rings 23 is further saturated with the inert gas. The inert gas serves as a protective atmosphere, so that when the cable is intact, the polyphenol oxidase coated on the inner wall of each of the warning rings 23 is less susceptible to oxidation. Only when breakage occurs and air infiltrates into the self-sensing passage, the warning rings 23 undergo a color change, thereby effectively reducing false alarms.

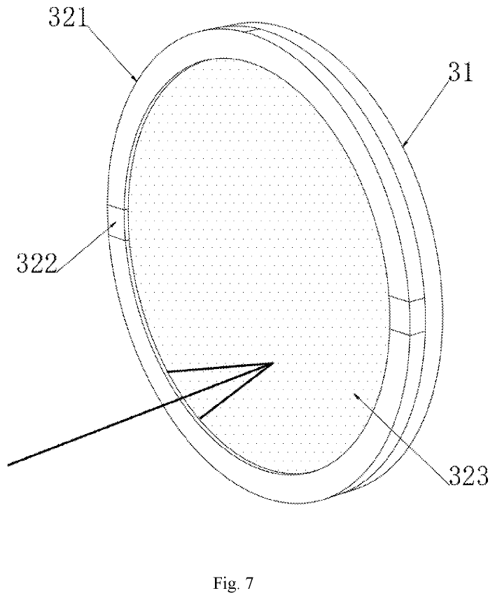

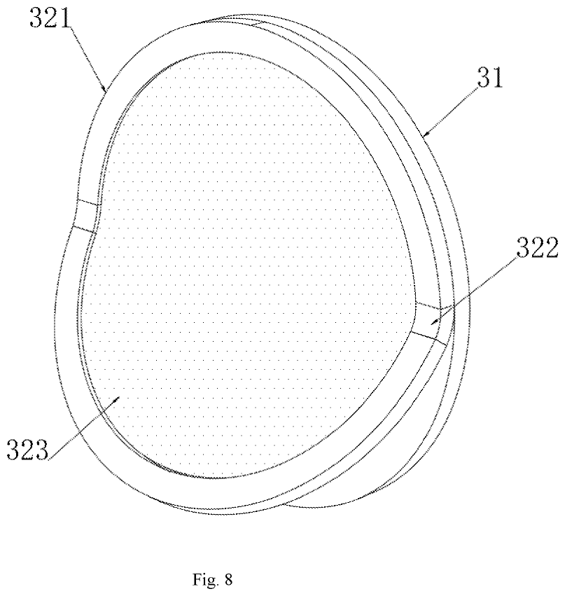

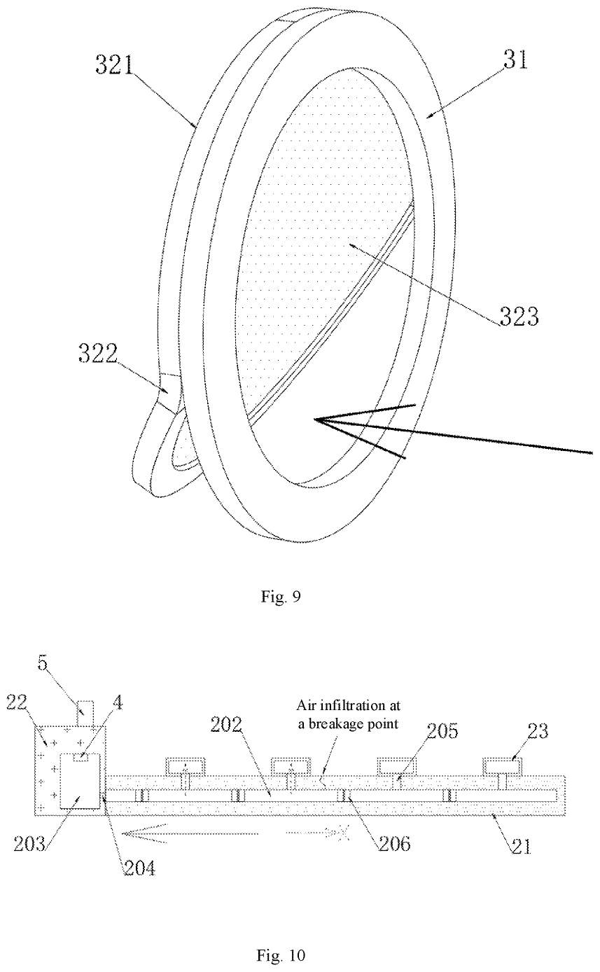

As shown in FIG. 7, the unidirectional gas blocking piece 3 includes a positioning ring 31 and a self-adaptive piece fixedly connected to an end of the positioning ring 31 close to the node ring 22, so that gas can only move toward a side close to the node ring 22 and cannot move in a reverse direction. The self-adaptive piece includes two wall-attaching half-rings 321, a pre-bent section 322 fixedly connected between end portions of the two wall-attaching half-rings 321, and a shielding piece 323 fixedly connected to inner walls of the two wall-attaching half-rings 321 and an inner wall of the pre-bent section 322. The pre-bent section 322 and the two wall-attaching half-rings 321 together form a complete ring. An upper one of the wall-attaching half-rings 321 is fixedly connected to the positioning ring 31. A lower one of the wall-attaching half-rings 321 is in contact with but not fixed to the positioning ring 31. Each of the two wall-attaching half-rings 321 is of a rigid structure. The pre-bent section 322 is of an elastic structure. The shielding piece 323 is made of a sealed flexible material. As shown in FIGS. 8-9, after breakage occurs, gas flowing toward the side close to the node ring 22 can push the shielding piece 323 and the lower one of the wall-attaching half-rings 321 to enter the collection cavity 203, so that air can be detected by the air sensor 4. In the direction away from the node ring 22, under restriction of the positioning ring 31, the lower one of the wall-attaching half-rings 321 remains in contact with the positioning ring 31, so that the entire unidirectional gas blocking piece 3 is in a closed state, thereby preventing gas from moving toward the side away from the node ring 22. Consequently, the warning rings 23 on the side of the breakage point close to the node ring 22 change color, facilitating indication of the breakage point.

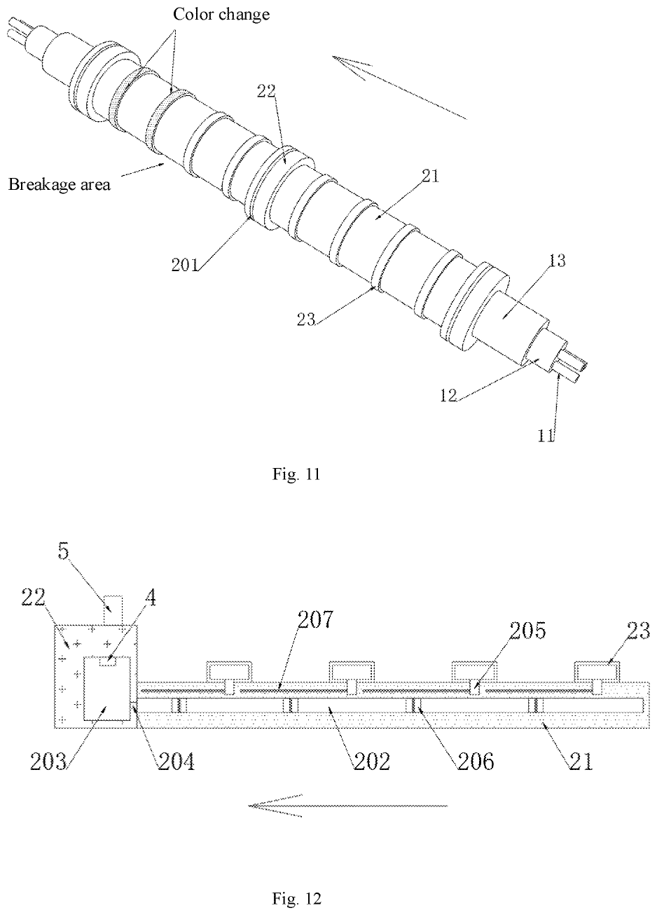

As shown in FIG. 10, when breakage occurs and a breakage depth reaches the annular inner cavity 202, air infiltrates and sequentially passes through the plurality of annular inner cavities 202, the passage holes 206, and the vent hole 204 to reach the collection cavity 203. Air enters each of the plurality of warning rings 23 located between the breakage point and the node ring 22, so that the plurality of warning rings 23 between the breakage point and the node ring 22 all undergo a color change. Due to the unidirectional passage property of the unidirectional gas blocking piece 3, the warning rings 23 on the reverse side are unlikely to change color. When an operator arrives on site for maintenance, as shown in FIG. 11, the operator first determines a color-changed portion, then searches for the color-changed warning ring 23 farthest from the node ring 22. The breakage point is in the vicinity of the farthest color-changed warning ring 23. The range of the breakage point can be effectively narrowed, facilitating identification of an abnormal point and improving maintenance efficiency.

An indicating ring groove 201 is further defined at an outer portion of the node ring 22. The indicating ring groove 201 and the collection cavity 203 are offset from each other. The indicating ring groove 201 is used to indicate a cut-off point when the cable needs to be cut, so that the cable can be cut without damaging the internal self-sensing passage.

In summary, through the provision of a self-sensing passage, an inert gas filled in the self-sensing passage increases the overall elasticity of the cable when the cable is intact, thereby providing a buffering and protective effect for the cable. When breakage occurs in the cable, gas exchange takes place between the inert gas in the self-sensing passage and ambient air. On one hand, the gas exchange triggers an audible and visual alarm 5, thereby facilitating timely maintenance by an operator. On the other hand, under the action of a unidirectional gas blocking piece 3, a plurality of warning rings 23 located between a breakage point and a node ring 22 are caused to change color synchronously; this not only enlarges a warning area, but also assists the operator in quickly locating the breakage point, thereby improving maintenance efficiency. Moreover, compared with the prior art, the high-voltage cable provides a warning and allows maintenance and repair to be performed before the cable is completely broken down, thereby significantly reducing potential safety hazards.

### Embodiment 2

This embodiment provides annular outer cavities 207 on the basis of Embodiment 1, and the remaining parts are consistent with Embodiment 1.

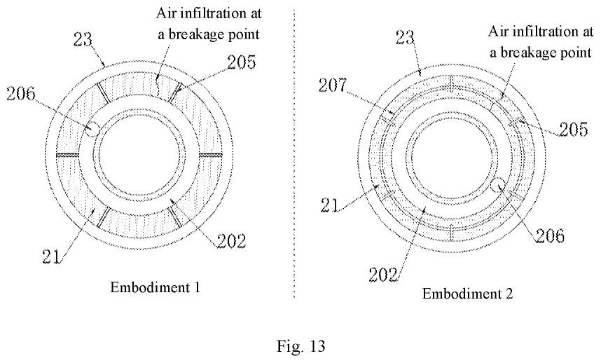

As shown in FIG. 12, the self-sensing passage further includes a plurality of annular outer cavities 207 formed inside the outer protective sleeve 21; the plurality of annular outer cavities 207 and the plurality of gas guide tubes 205 are arranged in a mutually spaced manner; and each of the plurality of annular outer cavities 207 is coaxial with a corresponding one of the annular inner cavities 202 and located outside the corresponding one of the annular inner cavities 202. Among one or two of the annular outer cavities 207 adjacent to the gas guide tube 205, the gas guide tube 205 is in fluid communication with one of the annular outer cavities 207 that is on a side close to the node ring 22.

As shown in FIG. 13, when external breakage occurs, a cracking path of the breakage first passes through the annular outer cavities 207. Because the plurality of annular outer cavities 207 are independent of one another, only the warning rings 23 in fluid communication with the broken annular outer cavities 207 undergo a color change. Since two annular inner walls of the annular outer cavities 207 are independent of each other, further propagation of the crack can also be effectively blocked. Meanwhile, the color change phenomenon can provide a certain warning to an operator patrolling nearby. If the crack is not handled in time and continues to propagate and reaches the annular inner cavities 202, gas exchange with ambient air occurs at this point. The air sensor 4 senses the air and triggers the audible and visual alarm 5, providing a clear warning to the operator. After the operator arrives on site, the range of the breakage point can be directly determined based on the color change condition of the warning rings 23, and maintenance can be performed. Thus, maintenance can be carried out before the high-voltage cable is completely broken down, significantly reducing potential safety hazards.

Compared with Embodiment 1, the indication range for the breakage point in Embodiment 2 is smaller and the accuracy is higher. During specific implementation, a suitable embodiment can be selected based on practical requirements.

Based on current practical requirements, the protection scope of the above embodiments adopted in the present disclosure is not limited thereto. Various changes made without departing from the concept of the present disclosure, within the knowledge scope of those skilled in the art, still fall within the protection scope of the present disclosure.

What is claimed is:

1. A high-voltage cable with a warning function, comprising a plurality of cable cores (11), an insulation layer (12) wrapped around outer portions of the plurality of cable cores (11), an inner protective layer (13) wrapped around the insulation layer (12), and a plurality of warning protective sleeves fixedly connected in sequence along an axial direction of the inner protective layer (13) and wrapped around an outer portion of the inner protective layer (13); wherein each of the warning protective sleeves comprises an outer protective sleeve (21), a node ring (22) fixedly connected to an end portion of the outer protective sleeve (21), and a plurality of warning rings (23) fixedly connected to an outer portion of the outer protective sleeve (21);
wherein a collection cavity (203) is defined inside the node ring (22); an air sensor (4) is disposed inside the collection cavity (203); an audible and visual alarm (5) is fixedly mounted on an outer portion of the node ring (22); the audible and visual alarm (5) is in signal connection with the air sensor (4); a self-sensing passage is defined inside the outer protective sleeve (21); a gas guide tube (205) is fixedly connected to an inner wall of each of the warning rings (23); and the gas guide tube (205) is fixedly arranged to extend through the outer portion of the outer protective sleeve (21) and is in fluid communication with the self-sensing passage; and
wherein the self-sensing passage comprises a plurality of annular inner cavities (202) and a plurality of passage holes (206) respectively located between every two adjacent annular inner cavities (202); the plurality of passage holes (206) and the plurality of warning rings (23) are arranged in a mutually spaced manner; a unidirectional gas blocking piece (3) is fixedly connected to an inner wall of each of the passage holes (206); a vent hole (204) is further defined at an end of the node ring (22) facing the outer protective sleeve (21); the vent hole (204) communicates one of the annular inner cavities (202) with the collection cavity (203); and the collection cavity (203) and the plurality of annular inner cavities (202) are each saturated with an inert gas.

2. The high-voltage cable with a warning function according to claim 1, wherein each of the warning rings (23) is of a hollow transparent structure, and an inner wall of each of the warning rings (23) is coated with polyphenol oxidase.

3. The high-voltage cable with a warning function according to claim 2, wherein the gas guide tube (205) is in fluid communication with a corresponding one of the annular inner cavities (202), and an inner portion of each of the warning rings (23) is further saturated with the inert gas.

4. The high-voltage cable with a warning function according to claim 1, wherein the unidirectional gas blocking piece (3) comprises a positioning ring (31) and a self-adaptive piece fixedly connected to an end of the positioning ring (31) close to the node ring (22); the self-adaptive piece comprises two wall-attaching half-rings (321), a pre-bent section (322) fixedly connected between end portions of the two wall-attaching half-rings (321), and a shielding piece (323) fixedly connected to inner walls of the two wall-attaching half-rings (321) and an inner wall of the pre-bent section (322); and the pre-bent section (322) and the two wall-attaching half-rings (321) together form a complete ring.

5. The high-voltage cable with a warning function according to claim 4, wherein an upper one of the wall-attaching half-rings (321) is fixedly connected to the positioning ring (31); a lower one of the wall-attaching half-rings (321) is in contact with but not fixed to the positioning ring (31); each of the two wall-attaching half-rings (321) is of a rigid structure; the pre-bent section (322) is of an elastic structure; and the shielding piece (323) is made of a sealed flexible material.

6. The high-voltage cable with a warning function according to claim 1, wherein an indicating ring groove (201) is further defined at an outer portion of the node ring (22), and the indicating ring groove (201) and the collection cavity (203) are offset from each other.

7. The high-voltage cable with a warning function according to claim 2, wherein the self-sensing passage further comprises a plurality of annular outer cavities (207) formed inside the outer protective sleeve (21); the plurality of annular outer cavities (207) and the plurality of gas guide tubes (205) are arranged in a mutually spaced manner; and each of the plurality of annular outer cavities (207) is coaxial with a corresponding one of the annular inner cavities (202) and located outside the corresponding one of the annular inner cavities (202).

8. The high-voltage cable with a warning function according to claim 7, wherein among one or two of the annular outer cavities (207) adjacent to the gas guide tube (205), the gas guide tube (205) is in fluid communication with one of the annular outer cavities (207) that is on a side close to the node ring (22).
